(19) United States
(12) Patent Application Publication
(10) Pub. No.: US 2024/0196771 A1
(43) Pub. Date: Jun. 20, 2024

(54) SYSTEM AND METHOD FOR MONITORING PLUGGING OF BASKET ASSEMBLIES OF AN AGRICULTURAL IMPLEMENT

(71) Applicant: CNH Industrial Canada, Ltd., Saskatoon (CA)

(72) Inventor: James W. Henry, Saskatoon (CA)

(21) Appl. No.: 18/084,255

(22) Filed: Dec. 19, 2022

(51) Int. Cl. A01B 29/04; A01B 29/06

(52) U.S. Cl. CPC A01B 29/048; A01B 29/06

(57) ABSTRACT

An agricultural implement includes a frame and a basket assembly supported on the frame such that the basket assembly is configured to roll relative to a surface of a field as the agricultural implement travels across the field, with the basket assembly including a plurality of bars spaced circumferentially about an outer perimeter of the basket assembly. Furthermore, the agricultural implement includes a sensor configured to generate data indicative of a width of a bar of the plurality of the bars. Additionally, the agricultural implement includes a computing system communicatively coupled to the sensor. In this respect, the computing system is configured to determine the width of the bar based on the data generated by the sensor. Moreover, the computing system is configured to determine when the basket assembly is plugged based on the determined width.

### FIELD OF THE INVENTION

The present disclosure generally relates to agricultural implements and, more particularly, to systems and methods for monitoring plugging of rolling basket assemblies of an agricultural implement.

### BACKGROUND OF THE INVENTION

It is well known that, to attain the best agricultural performance from a field, a farmer must cultivate the soil, typically through a tillage operation. Modern farmers perform tillage operations by pulling a tillage implement behind an agricultural work vehicle, such as a tractor. Tillage implements typically include one or more ground-engaging tools configured to engage the soil as the implement is moved across the field. For example, in certain configurations, the implement may include one or more harrow disks, leveling disks, rolling baskets, shanks, tines, and/or the like. Such ground-engaging tool(s) loosen, agitate, and/or otherwise work the soil to prepare the field for subsequent planting operations.

During tillage operations, field materials, such as residue, soil, rocks, mud, and/or the like, may become trapped or otherwise accumulate on and/or within ground-engaging tools or between adjacent ground-engaging tools. For instance, material accumulation will often occur around the exterior of a basket assembly (e.g., on the blades or bars of the basket assembly) and/or within the interior of the basket assembly. Such accumulation of field materials may prevent the basket assembly from performing in a desired manner during the performance of a tillage operation. In such instances, it is often necessary for the operator to take certain corrective actions to remove the material accumulation. However, it is typically difficult for the operator to detect or determine a plugged condition of a basket assembly when viewing the tools from the operator's cab.

Accordingly, an improved system and method for monitoring plugging of basket assemblies of an agricultural implement would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to an agricultural implement. The agricultural implement includes a frame and a basket assembly supported on the frame such that the basket assembly is configured to roll relative to a surface of a field as the agricultural implement travels across the field, with the basket assembly including a plurality of bars spaced circumferentially about an outer perimeter of the basket assembly. Furthermore, the agricultural implement includes a sensor configured to generate data indicative of a width of a bar of the plurality of the bars. Additionally, the agricultural implement includes a computing system communicatively coupled to the sensor. In this respect, the computing system is configured to determine the width of the bar based on the data generated by the sensor. Moreover, the computing system is configured to determine when the basket assembly is plugged based on the determined width.

In another aspect, the present subject matter is directed to a system for monitoring basket plugging of an agricultural implement. The system includes a basket assembly configured to roll relative to a surface of a field as the agricultural implement travels across the field, with the basket assembly including a plurality of bars spaced circumferentially about an outer perimeter of the basket assembly. Furthermore, the system includes a sensor configured to generate data indicative of a width of a bar of the plurality of the bars. Additionally, the system includes a computing system communicatively coupled to the sensor. As such, the computing system is configured to determine the width of the bar based on the data generated by the sensor. Moreover, the computing system is configured to determine when the basket assembly is plugged based on the determined width.

In a further aspect, the present subject matter is directed to a method for monitoring basket plugging of an agricultural implement. The agricultural implement, in turn, includes a basket assembly configured to roll relative to a surface of a field as the agricultural implement travels across the field, with the basket assembly including a plurality of bars spaced circumferentially about an outer perimeter of the basket assembly. The method includes receiving, with a computing system, sensor data indicative of a width of a bar of the plurality of the bars. Furthermore, the method includes determining, with the computing system, the width of the bar based on the received sensor data. Additionally, the method includes determining, with the computing system, when the basket assembly is plugged based on the determined width. Moreover, the method includes initiating, with the computing system, a control action associated with de-plugging the basket assembly when it is determined that the basket assembly is plugged.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of an agricultural implement coupled to a work vehicle in accordance with aspects of the present subject matter;

FIG. 2 illustrates another perspective view of the agricultural implement shown in FIG. 1 in accordance with aspects of the present subject matter;

FIG. 3 illustrates a perspective view of basket assemblies positioned at an aft end of the implement shown in FIGS. 1 and 2 in accordance with aspects of the present subject matter, particularly illustrating transceiver-based sensors installed relative to the basket assemblies;

FIGS. 4A and 4B illustrate simplified cross-sectional views of one of the basket assemblies shown in FIG. 3 when such basket assembly does not have field materials accumulated thereon in accordance with aspects of the present subject matter;

FIG. 5 illustrates similar simplified cross-sectional view of the basket assembly shown in FIGS. 4A and 4B, but with the basket assembly now having field materials accumulated thereon in accordance with aspects of the present subject matter;

FIG. 6 illustrates an exemplary plot showing an example data trace or profile associated with the sensor data collected by a transceiver-based sensor when a basket assembly does not have field materials accumulated thereon state in accordance with aspects of the present subject matter;

FIG. 7 illustrates an exemplary plot showing an example data trace or profile associated with the sensor data collected by a transceiver-based sensor of the disclosed system when a basket assembly has field materials accumulated thereon in accordance with aspects of the present subject matter;

FIG. 8 illustrates a perspective view of another embodiment of basket assemblies positioned at an aft end of an agricultural implement in accordance with aspects of the present subject matter, particularly illustrating an imaging device installed relative to the basket assemblies;

FIG. 9 illustrates a schematic view of one embodiment of a system for monitoring plugging of a basket assembly of an agricultural implement in accordance with aspects of the present subject matter

FIG. 10 illustrates a flow diagram providing one embodiment of control logic for monitoring plugging of a basket assembly of an agricultural implement in accordance with aspects of the present subject matter; and

FIG. 11 illustrates a flow diagram of one embodiment of a method for monitoring plugging of a basket assembly of an agricultural implement in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to a system and a method for monitoring basket plugging of an agricultural implement. As will be described below; the agricultural implement includes a basket assembly configured to roll relative to the surface of a field as the implement travels across the field. The basket assembly, in turn, includes a plurality of bars spaced circumferentially about the outer perimeter of the basket assembly. In this respect, as the basket assembly rolls relative to the field surface, the bars engage the soil to break up soil clods present on the surface. However, when a sufficient amount of field materials (e.g., soil, rocks, mud, residue, etc.) accumulates on and/or within the basket assembly, its operation may be impacted. In such instances, the basket assembly is considered plugged.

In several embodiments, a computing system of the disclosed system is configured to determine when the basket assembly is plugged by monitoring the width(s) of one or more of the bars. More specifically, when the basket assembly begins to plug, the field materials build up on the bars. Such accumulation occupy the portions of the space normally present between the bars, thereby effectively making the bars wider. As such, in such embodiments, the computing system is configured to receive sensor data indicative of the width(s) of one or more of the bars. Furthermore, the computing system is configured to determine the width(s) of the bar(s) based on the received sensor data. Additionally, when the determined width(s) exceeds a threshold value, the computing system may determine that the basket assembly is plugged. Thereafter, when it is determined that the basket assembly is plugged, the computing system may initiate one or more control actions associated with de-plugging the basket assembly, such as adjusting the ground speed of the agricultural implement and/or the force being applied to the basket assembly.

Determining when a basket assembly is plugged by monitoring the width(s) of one or more of its bars provides early detection of plugging. More specifically, when a basket assembly begins to plug, the field materials first build up on the bars. After sufficient accumulation on the bars, the field materials then begin to accumulate within the interior of the basket assembly. Such accumulations within the basket assembly are particularly impactful to the operation of the basket assembly. In this respect, by monitoring the width(s) of one or more of bars of a basket assembly, the disclosed system can detect plugging of the basket assembly before appreciable amounts of field materials begin to accumulate within the interior of the basket assembly. Such early detection of plugging allows for corrective actions to be taken before significant plugging of the basket assembly has occurred.

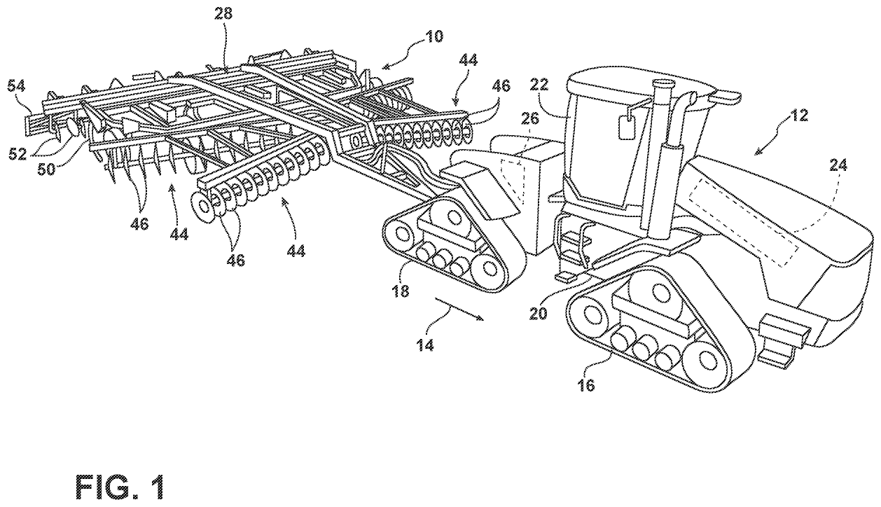

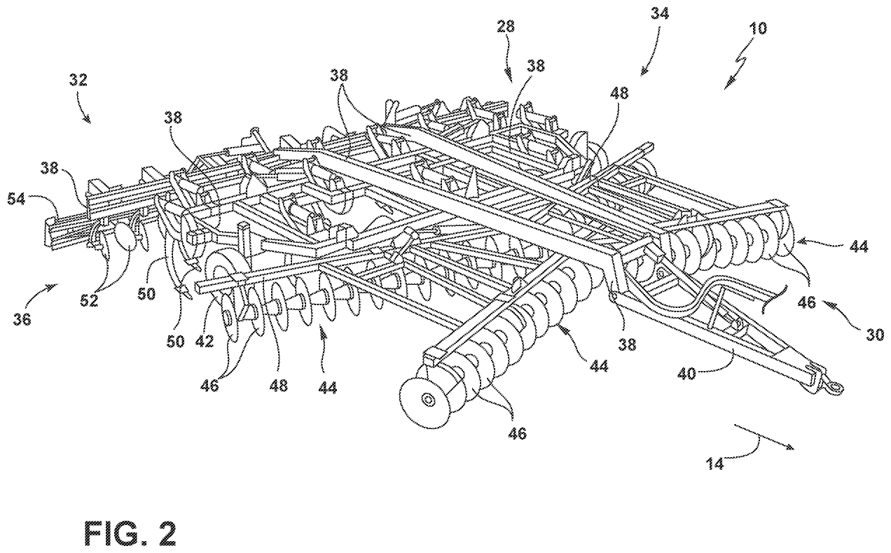

Referring now to the drawings, FIGS. 1 and 2 illustrate differing perspective views of one embodiment of an agricultural implement 10 in accordance with aspects of the present subject matter. Specifically, FIG. 1 illustrates a perspective view of the agricultural implement 10 coupled to a work vehicle 12. Additionally, FIG. 2 illustrates a perspective view of the implement 10, particularly illustrating various components of the implement 10.

In general, the implement 10 may be configured to be towed across a field in a direction of travel (e.g., as indicated by arrow 14 in FIG. 1) by the work vehicle 12. As shown, the implement 10 is configured as a tillage implement, and the work vehicle 12 is configured as an agricultural tractor. However, in other embodiments, the implement 10 may be configured as any other suitable type of implement, such as a seed-planting implement, a fertilizer-dispensing implement, and/or the like. Similarly, the work vehicle 12 may be configured as any other suitable type of vehicle, such as an agricultural harvester, a self-propelled sprayer, and/or the like.

As shown in FIG. 1, the work vehicle 12 may include a pair of front track assemblies 16, a pair or rear track assemblies 18, and a frame or chassis 20 coupled to and supported by the track assemblies 16, 18. An operator's cab 22 may be supported by a portion of the chassis 20 and may house various input devices for permitting an operator to control the operation of one or more components of the work vehicle 12 and/or one or more components of the implement 10. Additionally, the work vehicle 12 may include an engine 24 and a transmission 26 mounted on the chassis 20. The transmission 26 may be operably coupled to the engine 24 and may provide variably adjusted gear ratios for transferring engine power to the track assemblies 16, 18 via a drive axle assembly (not shown) (or via axles if multiple drive axles are employed).

As shown in FIGS. 1 and 2, the implement 10 may include a frame 28. More specifically, as shown in FIG. 2, the frame 28 may extend longitudinally between a forward end 30 and an aft end 32. The frame 28 may also extend laterally between a first side 34 and a second side 36. In this respect, the frame 28 generally includes a plurality of structural frame members 38, such as beams, bars, and/or the like, configured to support or couple to a plurality of components. Furthermore, a hitch assembly 40 may be connected to the frame 28 and configured to couple the implement 10 to the work vehicle 12. Additionally, a plurality of wheels 42 (one is shown) may be coupled to the frame 28 to facilitate towing the implement 10 in the direction of travel 14.

In several embodiments, the frame 28 may be configured to support various ground-engaging tools. For instance, the frame 28 may support one or more gangs or sets 44 of disk blades 46. Each disk blade 46 may be configured to penetrate into or otherwise engage the soil as the implement 10 is being pulled through the field. In this regard, the various disk gangs 44 may be oriented at an angle relative to the direction of travel 14 to promote more effective tilling of the soil. In the embodiment shown in FIGS. 1 and 2, the implement 10 includes four disk gangs 44 supported on the frame 28 adjacent to its forward end 30. However, in alternative embodiments, the implement 10 may include any other suitable number of disk gangs 44, such as more or fewer than four disk gangs 44. Furthermore, in one embodiment, the disk gangs 44 may be mounted to the frame 28 at any other suitable location, such as adjacent to its aft end 32.

Additionally, as shown, in one embodiment, the implement frame 28 may be configured to support other ground-engaging tools. For instance, in the illustrated embodiment, the frame 28 supports a plurality of shanks 50 configured to rip or otherwise till the soil as the implement 10 is towed across the field. Furthermore, in the illustrated embodiment, the frame 28 is also configured to support one or more finishing tools, such as a plurality of leveling blades 52 and/or rolling (or crumbler) basket assemblies 54. However, in other embodiments, any other suitable ground-engaging tools may be coupled to and supported by the implement frame 28, such as a plurality of closing disks.

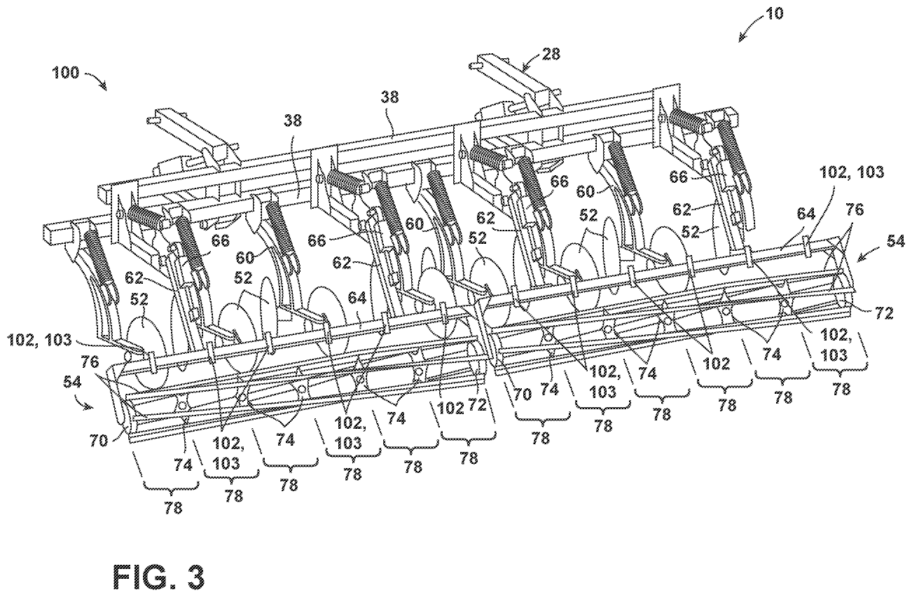

Referring now to FIG. 3, a perspective view of the aft end of the implement 10 shown in FIGS. 1 and 2 is illustrated in accordance with aspects of the present subject matter, particularly illustrating the finishing tools 52, 54 of the implement 10. As shown, the various finishing tools 52, 54 may be coupled to or supported by the implement frame 28, such as by coupling each tool to a toolbar or laterally extending frame member 38 of the frame 28. For instance, as shown in FIG. 3, a blade support arm 60 may be coupled between a given frame member 38 and each leveling blade 52 or set of leveling blades 52 to support the blades 52 relative to the frame 28. Similarly, one or more basket support arms 62 may be coupled between a given frame member 38 and an associated mounting yoke or basket hanger 64 for supporting each basket assembly 54 relative to the frame 28. Additionally, as shown in FIG. 3, in one embodiment, a basket actuator 66 (e.g., a hydraulic or pneumatic cylinder, an electric linear actuator, etc.) may be coupled to each basket support arm 62 to allow the force or pressure applied to each basket assembly 54 to be adjusted. The basket actuators 66 may also allow the basket assemblies 54 to be raised off the ground, such as when the implement 10 is making a headland turn and/or when the implement 10 is being operated within its transport mode.

In several embodiments, each basket assembly 54 includes a plurality of support plates 70, 72, 74 configured to support a plurality of blades or bars 76 spaced circumferentially about an outer perimeter of the basket. For instance, as shown in FIG. 3, each basket assembly 54 includes first and second end plates 70, 72 positioned at the opposed lateral ends of the basket assembly 54 and a plurality of inner support plates 74 spaced apart laterally from one another between the end plates 70, 72. Lateral basket sections 78 are generally defined between each pair of adjacent support plates 70, 72, 74, with each basket section 78 being generally characterized by a hollow or substantially hollow interior area surrounded by the lateral portions of the bars 76 extending between the respective pair of adjacent support plates 70, 72, 74. Moreover, the end plates 70, 72 may be rotatably coupled to the corresponding basket hanger 64 (which, in turn, is coupled to the associated bracket support arm(s) 62) via bearings to allow the basket assembly 54 to rotate relative to the hanger/arm 64, 62 as implement 10 travels across the field. Additionally, in the illustrated embodiment, the bars 76 of each basket assembly 54 are configured as formed bars. However, in other embodiments, the bars 76 may have any other suitable configuration, such as flat bars, round bars, and/or the like.

It should be further appreciated that the configuration of the agricultural implement 10 and the work vehicle 12 described above and shown in FIGS. 1-3 is provided only to place the present subject matter in an exemplary field of use. Thus, it should be appreciated that the present subject matter may be readily adaptable to any manner of agricultural and/or work vehicle configuration.

Moreover, one or more sensors 102 are installed or otherwise mounted on the implement 10. In general, the sensor(s) 102 is configured to generate data indicative of the width(s) of one or more of the bars 76 of the basket assembly(ies) 54. Thus, the sensor(s) 102 is generally installed on the implement 10 adjacent to the basket assembly(ies) 54. As will be described below, the data generated by the sensor(s) 102 is used to determine when field materials have accumulated on the bars 76 such that the basket assembly(ies) 54 is becoming plugged.

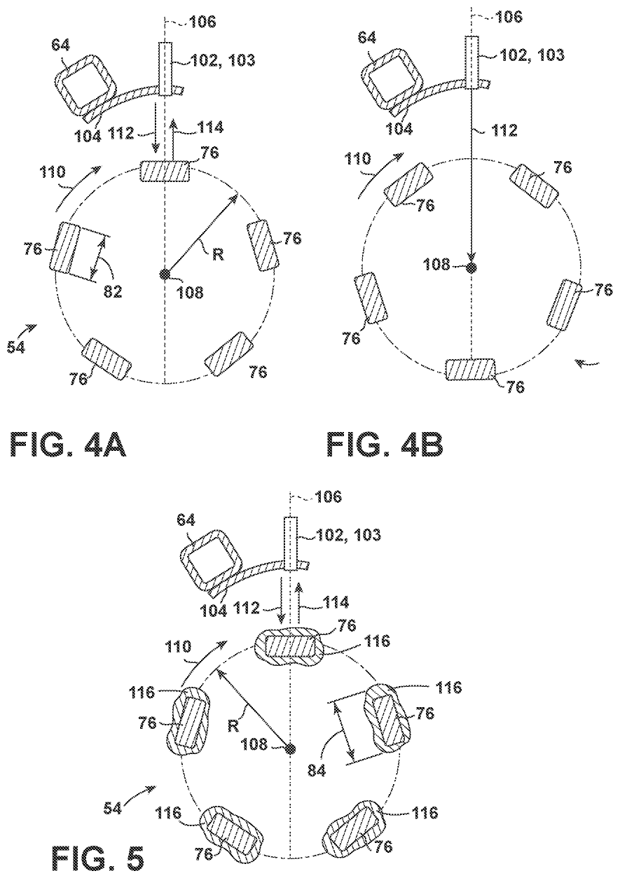

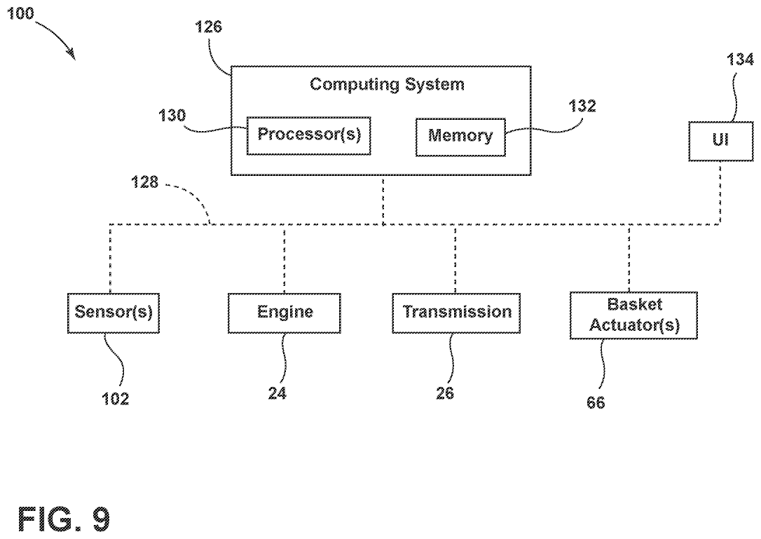

In several embodiments, the sensor(s) 102 is configured as a transceiver-based sensor(s) 103. More specifically, as shown in FIG. 3, in such embodiments, a plurality of the transceiver-based sensor(s) 103 are installed on the implement 10 at a location relative to the basket assemblies 54 such that each sensor 103 is configured to generate data indicative of the widths of the bars 76 of the corresponding basket assembly 54. For example, in some embodiments, each transceiver-based sensor 103 may be installed relative to an adjacent basket assembly 54 such that the sensor 103 is configured to transmit output signals towards the interior of the basket assembly 54 along a line of sight or line of detection 106 (FIGS. 4A, 4B, and 5) of the sensor 103 and subsequently receive return signals corresponding to the output signals as reflected off a given surface aligned with the line of detection 106 at such point in time, such as the outer surfaces of the bars 76 or the surfaces of field materials that have accumulated on the outer surfaces of the bars 76. Alternatively, in other embodiments, each transceiver-based sensor 103 may be installed within one of the basket assemblies 54 such that the sensor 103 is configured to transmit output signals towards the exterior of the corresponding basket assembly 54 and subsequently receive return signals corresponding to the output signals as reflected off of the inner surfaces of the bars 76 or the surfaces of field materials that have accumulated on the inner surfaces of the bars 76. By analyzing the return signals via an associated computing system 126 (FIG. 9) communicatively coupled to each sensor 102, the computing system 126 may be configured to identify the presence of material accumulation on the bars 76 of the basket assemblies 54. Such accumulations of field materials are, in turn, indicative of plugging of the basket assemblies 54.

In general, the return signals received by each transceiver-based sensor 103 may be indicative of the distance defined between the sensor 103 and the corresponding reflection surface. In this regard, as the basket assembly 54 is rotated relative to each transceiver-based sensor 103, the output signals transmitted from such sensor 103 at any given point in time will either be directed towards one of the bars 76 surrounding the interior of the basket assembly 54 or the open space defined between adjacent bars 76, depending on the rotational orientation of the basket assembly 54 relative to the sensor 103 at such point in time. As a result, the profile of the distance-related data associated with the return signals received by each transceiver-based sensor 103 will generally correspond to a periodic or wave-like profile. Specifically, the profile may generally have alternating peaks and valleys, with the peaks corresponding to reflections of the output signals off of the bars 76 and the valleys corresponding to transmission of the output signals between adjacent bars 76 and through the open interior of the basket assembly 54. In this respect, by determining the widths of the peaks, the widths of the bars 76 can be determined. As the amount of materials accumulate on the bars 76 increases, the detected widths of the bars 76 similarly increase. In such instances, the widths of the peaks become larger and valleys become smaller. Thus, by determining the widths of the bars 76 based on the data generated by the transceiver-based sensor(s) 103, the computing system 126 can determine when field materials have accumulated on the bars 76 such that the basket assembly(ies) 54 are becoming plugged. Once plugging is detected, an appropriate control action may then be executed, such as by notifying the operator of the plugged condition or by performing an automated control action.

The transceiver-based sensor(s) 103 may correspond to any suitable distance sensors, proximity sensors, and/or the like that are configured to generate data indicative of a distance or range defined between such sensors 103 and a given object/surface. For instance, in one embodiment, each transceiver-based sensor 103 may correspond to an optical distance sensor, such as a laser-based distance sensor. In another embodiment, each transceiver-based sensor 103 may correspond to ultrasound-based distance sensor. Laser-based distance sensors and ultrasound-based distance sensors suitable for use are commercially available from various sources, including, for example, from Banner Engineering Corp. of Minneapolis, MN. In other embodiments, each transceiver-based sensor 103 may correspond to any other suitable distance or proximity sensor or sensing device, such as a radar-based distance sensor, an inductance-based distance sensor, a sonar-based distance sensor, magnetic-based distance sensor, a LiDAR sensor, and/or the like.

As shown in FIG. 3, the transceiver-based sensors 103 are mounted to the basket hanger 64 supporting each basket assembly 54 relative to the implement frame 28 (e.g., via the associated basket support arm 62) in a manner such that each sensor 103 has a downwardly oriented line of sight or line of detection 106 (FIGS. 4A, 4B, and 5) directed towards the interior of the adjacent basket assembly 54. Specifically, in the illustrated embodiment, the transceiver-based sensors 103 are spaced apart laterally across each basket hanger 64 such that at least one transceiver-based sensor 103 has a downwardly oriented line of detection directed towards the interior of each lateral basket section 78 of the adjacent basket assembly 54. As a result, the transceiver-based sensors 103 may allow the material accumulation on the bars 76 of each respective basket section 78 to be individually monitored. However, in other embodiments, the transceiver-based sensors 103 may be mounted at any other suitable location relative to the basket assembly 54 that allows each sensor 103 to have a line of detection directed towards the interior of an associated basket assembly 54. Additionally, although the illustrated embodiment shows a specific number of transceiver-based sensors 102 installed relative to each basket assembly 54 (e.g., one per each lateral basket section 78), the implement 10 may generally include any suitable number of sensors 103, including a single sensor 103 for each basket assembly 54.

Referring now to FIGS. 4A, 4B, and 5, schematic, simplified cross-sectional views of one of the basket assemblies 54 shown in FIG. 3 are illustrated in accordance with aspects of the present subject matter. Specifically, FIGS. 4A and 4B illustrate the basket assembly 54 when the bars 76 are completely devoid of material accumulation. Additionally, FIG. 5 illustrates the basket assembly 54 when field materials (indicated by masses 116) have accumulated on its bars 76.

As shown, the transceiver-based sensor 103 is coupled to the adjacent basket hanger 64 (e.g., via a mounting bracket 104) such that the sensor 103 has a line of detection 106 oriented towards the interior of the basket assembly 54. Specifically, in the illustrated embodiment, the line of detection 106 of the transceiver-based sensor 103 is directed towards a center 108 of the basket assembly 54, which may also correspond to the location of the rotational axis of the basket assembly 54. However, in other embodiments, the line of detection 106 of the transceiver-based sensor 103 may be directed towards any other location(s) within the interior of the basket assembly 54, such as any off-center location.

As particularly shown in FIGS. 4A and 4B, as the basket assembly 54 devoid of material build-up rotates in a given rotational direction (e.g., as indicated by arrow 110) across the ground (and relative to the sensor 102) during the performance of an agricultural operation (e.g., a tillage operation), the line of detection 106 of the transceiver-based sensor 103 alternates from being aligned with one of the bars 76 of the basket assembly 54 to being aligned with the open area or gap defined adjacent bars 76. For example, in the snapshot shown in FIG. 4A, the line of detection 106 is aligned with one of the bars 76 of the basket assembly 54. As a result, the output signals (indicated by arrow 112) transmitted from the transceiver-based sensor 103 may reflect off the outer surface of the aligned bar 76 and be directed back to the transceiver-based sensor 103 as return signals (indicated by arrow 114). Such return signals 114 may then be analyzed, for example, to identify the distance between the transceiver-based sensor 103 and the aligned bar 76 (or, as will be described below, to identify distance between the aligned bar 76 and the basket center 108 via a linear transformation). In contrast, in the subsequent snapshot shown in FIG. 4B in which the basket assembly 54 has rotated slightly in the rotational direction 110 from the position shown in FIG. 4A, the line of detection 106 is aligned with the open space defined between adjacent bars 76 of the basket assembly 54. As a result, the output signals 112 transmitted from the transceiver-based sensor 103 may pass between the adjacent bars 76 and through the open interior of the basket assembly 54 to the basket center 108 or beyond. As the basket assembly 54 is further rotated in the rotational direction 110 from the position shown in FIG. 4B, the next adjacent bar 76 will pass through the line of detection 106 of the transceiver-based sensor 103, thereby allowing the sensor 103 to detect the bar. Such alternating pattern will be repeated as the basket assembly 54 rotates relative to the transceiver-based sensor 103 during operation of the agricultural implement 10.

In the illustrated embodiment, the detection range of the transceiver-based sensor 103 has generally been selected to generally correspond to the distance defined between the sensor 103 and the basket center 108. As a result, the transceiver-based sensor 103 will not receive return signals 114 when the line of detection 106 for the sensor 103 is aligned with the open space between adjacent bars 76 (e.g., as shown in FIG. 4B), thereby indicating that the output signals 112 reached the center 108 of the basket assembly 54. In this respect, and as will be described below, a width 82 of each bar 76 of the basket assembly 54 can be determined based on the time periods across which the transceiver-based sensor 103 receives the returns 114. In other embodiments, the transceiver-based sensor 103 may have any other suitable detection range. For instance, in another embodiment, the detection range may be selected to correspond to the distance defined between the transceiver-based sensor 103 and the ground (or the opposed side of the basket assembly 54 contacting the ground). In such an embodiment, when the line of detection 106 for the transceiver-based sensor 103 is aligned with the open space between adjacent bars 76 (e.g., as shown in FIG. 4B), the output signals 112 may be transmitted through the interior of the basket assembly 54 and reflect off the opposed side of the basket assembly 54 (e.g., a bar positioned at such opposed side) or the ground and be returned back to the transceiver-based sensor 103 as suitable return signals.

When field materials have accumulated on the bars 76 of the basket assembly 54, the same alternating pattern will be repeated as the basket assembly 54 rotates relative to the transceiver-based sensor 103 during operation of the agricultural implement 10, with the line of detection 106 alternating between being aligned with the materials accumulated on one of the bars 76 of the basket assembly 54 and being aligned with the open space defined between material accumulations on the bars 76. For instance, the line of detection 106 of the transceiver-based sensor 103 is aligned with the materials accumulated on one of the bars 76 of the basket assembly 54 in the snapshot shown in FIG. 5. As mentioned above, the field materials accumulated on the bars 76 effectively make the bars 76 wider. Thus, unlike the non-plugged state described above with reference to FIGS. 4A and 4B, the output signals 112 transmitted from the transceiver-based sensor 103 will not pass through portions of the spaces between the bars 76 where materials have accumulated when the line of detection 106 is aligned with such material accumulations where open space is normally present. In such instances, the generated data indicates that a width 84 of each bar 76 on which materials have accumulated is wider than the actual width 82 of each bar 76.

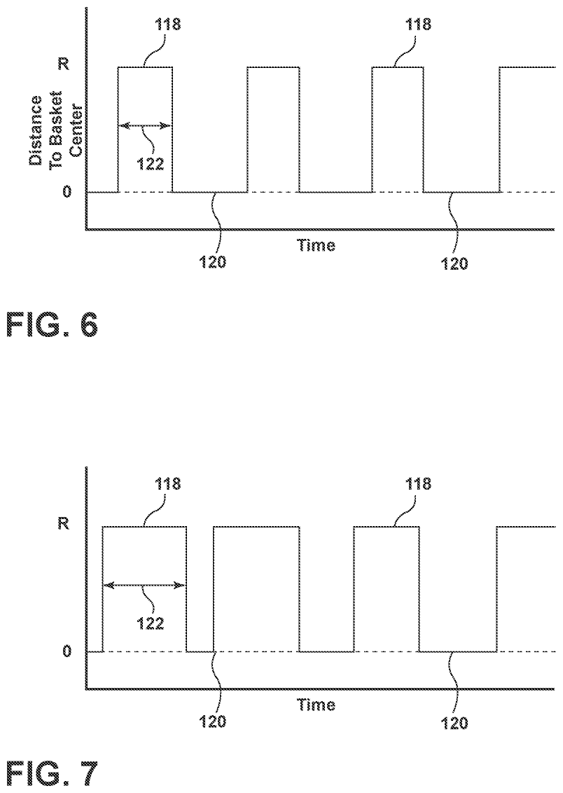

Referring now to FIGS. 6 and 7, exemplary charts are provided that illustrate example data traces or profiles associated with the sensor data generated by the transceiver-based sensor 103 in the non-plugged/plugged scenarios described above with reference to FIGS. 4A and 4B and FIG. 5. Specifically, FIG. 6 illustrates an exemplary data profile associated with the return signals 114 received by the transceiver-based sensor 103 (or lack thereof) when no material has accumulated on the bars 76 of the basket assembly 54 (e.g., the basket assembly 54 is in the non-plugged state) as shown in FIGS. 4A and 4B. Similarly, FIG. 7 illustrates an exemplary data profile associated with the return signals 114 received by the transceiver-based sensor 103 when material has accumulated on the bars 76 of the basket assembly 54 (e.g., the basket assembly 54 is beginning to plug) as shown in FIG. 5. The data collected from the transceiver-based sensor 103 is generally indicative of the distance defined between the transceiver-based sensor 103 and the detected surface(s). However, for purposes of illustration, the sensor data has been plotted as a function of the distance of the detected surface from the center 108 of the basket assembly 54. Such center-referenced data may be obtained via a linear transformation. In doing so, any sensor measurements that extend beyond the center 108 of the basket assembly 54 (e.g., when the detection range of the transceiver-based sensor 103 extends past the basket center 108) may be saturated prior to performing the linear transformation.

As particularly shown in FIG. 6, when no field materials have accumulated on the bars 76 of the basket assembly 54, the sensor data may exhibit a periodic or alternating profile as the line of detection 106 of the transceiver-based sensor 103 alternates between being aligned with one of the bars 76 and being aligned with the open spaces defined between adjacent bars 76. Specifically, the data trace is characterized by a repeating pattern of peaks 118 and valleys 120. Each peak 118, in turn, corresponds to the time period across which one of the bars 76 of the basket assembly 54 is being rotated across the line of detection 106 of the transceiver-based sensor 103. Similarly, each valley 120 corresponds to the time period across which the output signals 112 from the transceiver-based sensor 103 are being transmitted between adjacent bars 76 through the interior of the basket assembly 54 to at least the basket center 108. As shown in FIG. 6, each peak 118 has a width 122 corresponding to the widths 82 of the bars 76. Moreover, when no material has accumulated on the bars 76, the widths 122 of the peaks 118 are uniform as all of the bars 76 on the basket assembly 54 generally have the same width 82.

In contrast, as shown in FIG. 7, the data trace or profile associated with the sensor data received from the transceiver-based sensor 103 differs when field materials have accumulated on the basket assembly 54. More specifically, as mentioned above, material accumulations make the bars 76 appear to be wider than the bars 76 actually are. In this respect, the widths 122 of the peaks 118 shown in FIG. 7 are widths than the widths 122 of the peaks 118 shown in FIG. 6 as the field materials located where the open spaces between the bars 76 would normally be reflect the output signals 112. Moreover, when material has accumulated on the bars 76, the widths 122 of the peaks 118 are generally not uniform as differing amounts of material may have accumulated on the bars 76 on the basket assembly 54.

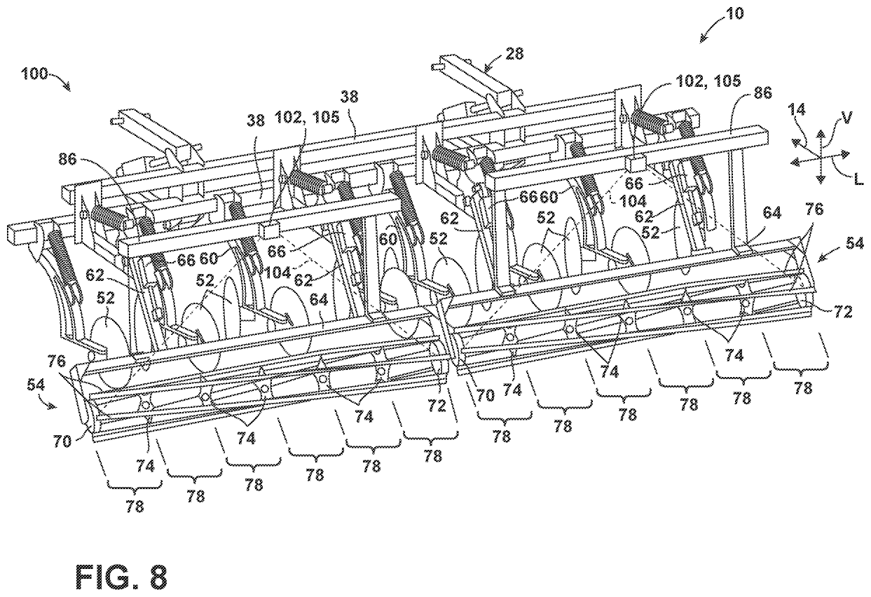

Referring now to FIG. 8, a perspective view of an alternative embodiment of the aft end of the implement 10 shown in FIGS. 1 and 2 is illustrated in accordance with aspects of the present subject matter. Like the embodiment shown in FIG. 3, the implement 10 includes the basket assemblies 54 and one or more sensors 102, with the sensors 102 configured to generate data indicative of the widths of the bars 76 of the basket assemblies 54. However, unlike the embodiment of FIG. 3, the sensors 102 are not configured as the transceiver-based sensors 103. Instead, as shown in FIG. 8, the sensors 102 are configured as imaging devices 105. In such embodiments, each imaging device 105 has a field of view directed at one of the basket assemblies 54. Thus, each imaging device 105 is configured to generate image data depicting the bars 76 of the basket assembly. In this respect, and as will be described below, the image data generated by the imaging device 105 may be analyzed to determine the widths of the bars 76.

In general, each imaging device 105 may correspond to any suitable device configured to capture images or other image data depicting the bars 76 of the basket assemblies 54. For example, in one embodiment, each imaging device 105 may correspond to stereographic cameras configured to generate three-dimensional images of the bars 76 of the basket assemblies 54 within its field of view. In other embodiments, each imaging device 105 may correspond to a monocular camera(s) configured to capture two-dimensional images of the bars 76 of the basket assemblies 54 present within its field of view. However, in alternative embodiments, each imaging device 105 may correspond to any other suitable sensing devices configured to capture images or image-like data, such as a LiDAR sensors or a RADAR sensors.

The imaging devices 105 may be installed at any suitable location(s) that allow the imaging devices 105 to capture images depicting the bars 76 of the basket assemblies 54. For example, in the illustrated embodiment, the imaging devices 105 are mounted on support arms 86 coupled to the basket assemblies 54. However, in alternative embodiments, the sensors 102 may be installed at any other suitable location(s). Additionally, any suitable number of sensors 102 may be installed on the implement 10.

Referring now to FIG. 9, a schematic view of one embodiment of a system 100 for monitoring plugging of a basket assembly of an agricultural implement is illustrated in accordance with aspects of the present subject matter. In general, the system 100 will be described herein with reference to the agricultural implement 10 and the work vehicle 12 described above with reference to FIGS. 1-8. However, it should be appreciated by those of ordinary skill in the art that the disclosed system 100 may generally be utilized with agricultural implements having any other suitable implement configuration and/or work vehicles having any other suitable vehicle configuration.

As shown in FIG. 9, the system 100 includes a computing system 126 communicatively coupled to one or more components of the agricultural implement 10, the work vehicle 12, and/or the system 100 to allow the operation of such components to be electronically or automatically controlled by the computing system 126. For instance, the computing system 126 may be communicatively coupled to the sensor(s) 102 (e.g., the transceiver-based sensors 103 or the imaging devices 105) via a communicative link 128. As such, the computing system 126 may be configured to receive data from the sensors 102 that is indicative of the widths of the bars 76 of the basket assemblies 54. Furthermore, the computing system 126 may be communicatively coupled to the engine 24, the transmission 26, and the basket actuator(s) 66 via the communicative link 128. In this respect, the computing system 126 may be configured to control the operation of the engine 24, the transmission 26, and/or the basket actuator(s) 66 to adjust the operation of the implement 10 and/or the vehicle 12 in a manner that facilitates de-plugging of the basket assemblies 54. In addition, the computing system 126 may be communicatively coupled to any other suitable components of the agricultural implement 10, the work vehicle 12, and/or the system 100.

In general, the computing system 126 may comprise one or more processor-based devices, such as a given controller or computing device or any suitable combination of controllers or computing devices. Thus, in several embodiments, the computing system 126 may include one or more processor(s) 130 and associated memory device(s) 132 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 132 of the computing system 126 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 132 may generally be configured to store suitable computer-readable instructions that, when implemented by the processor(s) 130, configure the computing system 126 to perform various computer-implemented functions, such as one or more aspects of the methods and algorithms that will be described herein. In addition, the computing system 126 may also include various other suitable components, such as a communications circuit or module, one or more input/output channels, a data/control bus and/or the like.

The various functions of the computing system 126 may be performed by a single processor-based device or may be distributed across any number of processor-based devices, in which instance such devices may be considered to form part of the computing system 126. For instance, the functions of the computing system 126 may be distributed across multiple application-specific controllers or computing devices, such as a navigation controller, an engine controller, a transmission controller, an implement controller, and/or the like.

In addition, the system 100 may also include a user interface 134. More specifically, the user interface 134 may be configured to provide feedback from the computing system 126 (e.g., feedback associated with plugging of the basket assemblies 54) to the operator. As such, the user interface 134 may include one or more feedback devices (not shown), such as display screens, speakers, warning lights, and/or the like, which are configured to provide feedback from the computing system 126 to the operator. As such, the user interface 134 may, in turn, be communicatively coupled to the computing system 126 via the communicative link 128 to permit the feedback to be transmitted from the computing system 126 to the user interface 134. Furthermore, some embodiments of the user interface 134 may include one or more input devices, such as touchscreens, keypads, touchpads, knobs, buttons, sliders, switches, mice, microphones, and/or the like, which are configured to receive inputs from the operator. In one embodiment, the user interface 134 may be mounted or otherwise positioned within the cab 22 of the work vehicle 12. However, in alternative embodiments, the user interface 134 may mounted at any other suitable location.

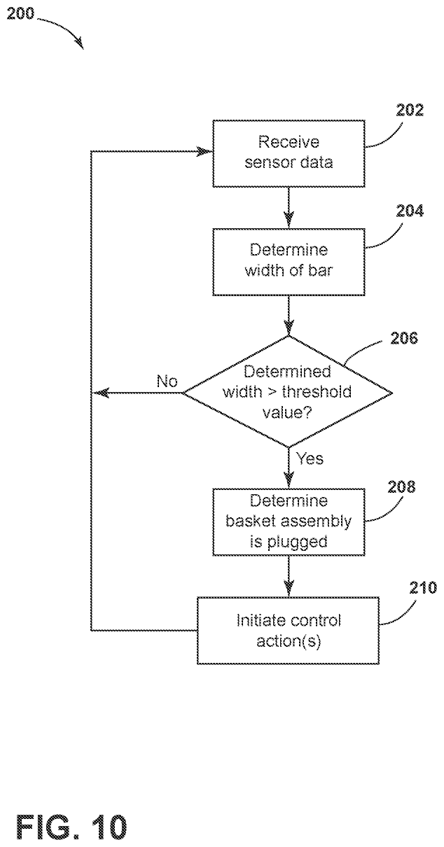

Referring now to FIG. 10, a flow diagram of one embodiment of example control logic 200 that may be executed by the computing system 126 (or any other suitable computing system) for monitoring plugging of a basket assembly of an agricultural implement is illustrated in accordance with aspects of the present subject matter. Specifically, the control logic 200 shown in FIG. 10 is representative of steps of one embodiment of an algorithm that can be executed to detect plugging of a basket assembly of an agricultural implement before appreciable amounts of field materials begin to accumulate within the interior of the basket assembly. Thus, in several embodiments, the control logic 200 may be advantageously utilized in association with a system installed on or forming part of an agricultural implement and/or an associated work vehicle to allow for real-time monitoring plugging of a basket assembly of an agricultural implement without requiring substantial computing resources and/or processing time. However, in other embodiments, the control logic 200 may be used in association with any other suitable system, application, and/or the like for monitoring plugging of a basket assembly of an agricultural implement.

As shown, at (202), the control logic 200 includes receiving sensor data indicative of a width of a bar of a plurality of bars of a basket assembly of an agricultural implement. Specifically, as mentioned above, in several embodiments, the computing system 126 may be communicatively coupled to the sensor(s) 102 (e.g., the transceiver-based sensors 103 or the imaging devices 105) via the communicative link 128. In this respect, as the implement/vehicle 10/12 travels across the field to perform an operation (e.g., a tillage operation) thereon, the computing system 126 may receive data from the sensor(s) 102. Such data may, in turn, be indicative of the widths of one or more of the bars 76 of the basket assemblies 54 of the implement 10.

Furthermore, at (204), the control logic 200 includes determining the width of the bar based on the received sensor data. Specifically, in several embodiments, the computing system 126 is configured to the width(s) of one or more of the bars 76 of the basket assemblies 54 of the implement 10 based on the sensor data received at (202). As will be described below, the determined width(s) of the bar(s) 76 are used to determine when the corresponding basket assembly 54 is plugged.

As mentioned above, in some embodiments, the sensor(s) 102 are configured as the transceiver-based sensors 103. The transceiver-based sensors 103, in turn, emit output signals directed at the basket assembly(ies) 54 and receive return signals based on reflections of the output signals off of the basket assembly(ies) 54. In such embodiments, the computing system 126 may be configured to analyze the return signals to determine the width(s) of one or more of the bars 76 of the basket assembly(ies) 54. For example, in one embodiment, the computing system 126 may determine the width(s) of the bar(s) 76 of the basket assembly(ies) 54 based on the time periods across which the return signals are received. However, in other embodiments, the computing system 126 may determine the width(s) of the bar(s) 76 of the basket assembly(ies) 54 based on the data generated by the transceiver-based sensor(s) 103 and received at (202) in any other suitable manner.

Additionally, as mentioned above, in some embodiments, the sensor(s) 102 is configured as the imaging device(s) 105, which generate image data depicting the basket assembly(ies) 54. In such embodiments, the computing system 126 may be configured to analyze the image data to determine the width(s) of the bar(s) 76 of the basket assembly(ies) 54. For example, in one embodiment, the computing system 126 may identify the bar(s) 76 of the basket assembly 54 depicted within the image data received at (202), such as using any suitable image processing techniques (e.g., a color-based image processing technique(s), a gradient-based image processing technique(s), etc.). Thereafter, the computing system 126 may determine the width(s) of the identified bar(s) 76 depicted within the image data.

However, in alternative embodiments, the width(s) of the bar(s) 76 may be determined at (204) in any other suitable manner.

Moreover, at (206), the control logic 200 includes comparing the determined width to a threshold value. More specifically, as described above, when the basket assemblies 54 begin to plug, the field materials build up on the bars 76. Such accumulations of field materials on the bars 76 decrease the amount of space between the bars 76, thereby effectively making the bars 76 wider. Thus, in several embodiments, the computing system 126 is configured to compare the width(s) of the bar(s) 76 determined at (204) a threshold value. When the determined width(s) of the bar(s) 76 are equal to or less than the threshold value, the corresponding basket assembly 54 is not plugged. In such instances, the control logic 200 returns to (202). Conversely, when the determined width(s) of the bar(s) 76 exceed the threshold value, the computing system 126 is configured to determine at (208) that the corresponding basket assembly(ies) 54 is plugged. Thereafter, the control logic 200 proceeds to (210).

In addition, at (210), the control logic 200 includes initiating a control action associated with de-plugging the basket assembly. Specifically, in several embodiments, the computing system 126 may be configured to initiate one or more control actions associated with de-plugging the basket assembly(ies) 54 when it is determined at (208) that such basket assembly(ies) 54 are plugged. For example, in one embodiment, the control action(s) include providing a notification to an operator of the agricultural implement 10 that the basket assembly(ies) 54 is plugged. In such an embodiment, the computing system 126 may transmit suitable control signals to the user interface 134 instructing the user interface 134 to provide the appropriate notification to the operator.

Alternatively, or additionally, the control action(s) include adjusting an operating parameter(s) of the implement 10 and/or the vehicle 12. For example, in one embodiment, the control action(s) may include adjusting (e.g., increasing) the ground speed of the implement/vehicle 10/12. In such an embodiment, the computing system 126 may transmit suitable control signals to the engine 24 and/or transmission 26 of the vehicle 12 instructing the engine 24 and/or transmission 26 to adjust (e.g., increase) the ground speed of the implement/vehicle 10/12. In a further embodiment, the control action(s) include adjusting the force being of the basket assembly(ies) 54 by the basket actuator(s) 66. In such an embodiment, the computing system 126 may transmit suitable control signals to the basket actuator(s) 66 of the implement 10 instructing the basket actuator(s) 66 to adjust force being applied to the basket assembly(ies) 54.

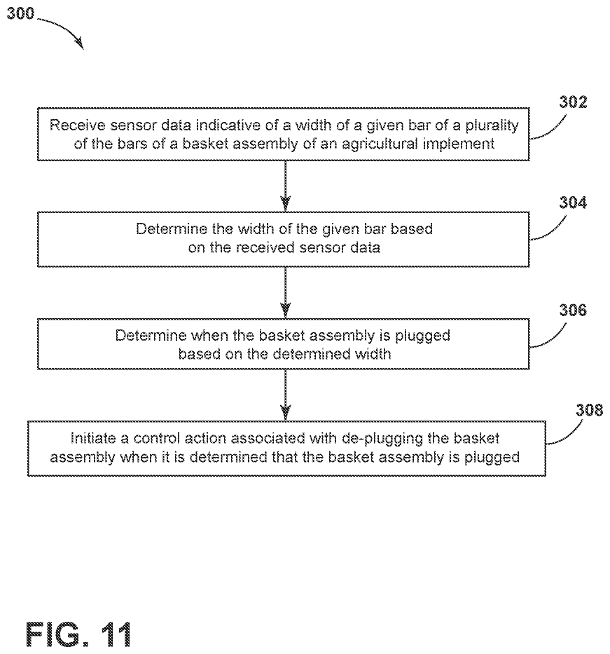

Referring now to FIG. 11, a flow diagram of one embodiment of a method 300 for monitoring plugging of a basket assembly of an agricultural implement is illustrated in accordance with aspects of the present subject matter. In general, the method 300 will be described herein with reference to the agricultural implement 10, the work vehicle 12, and the system 100 described above with reference to FIGS. 1-10. However, it should be appreciated by those of ordinary skill in the art that the disclosed method 300 may generally be implemented with any agricultural implement having any suitable implement configuration, any work vehicle having any suitable vehicle configuration, and/or within any system having any suitable system configuration. In addition, although FIG. 11 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 11, at (302), the method 300 includes receiving, with a computing system, sensor data indicative of a width of a bar of a plurality of the bars of a basket assembly of an agricultural implement. For instance, as described above, the computing system 126 may be configured to receive sensor data indicative of the width(s) of the bar(s) 76 of the basket assembly(ies) 54 of the implement 10 from the sensor(s) 102.

Furthermore, at (304), the method 300 includes determining, with the computing system, the width of the bar based on the received sensor data. For instance, as described above, the computing system 126 may be configured to determine the width(s) of the bar(s) 76 based on the received sensor data.

Additionally, at (306), the method 300 includes determining, with the computing system, when the basket assembly is plugged based on the determined width. For instance, as described above, the computing system 126 may be configured to determine when the basket assembly(ies) 54 is plugged based on the determined width(s).

Moreover, at (308), the method 300 includes initiating, with the computing system, a control action associated with de-plugging the basket assembly when it is determined that the basket assembly is plugged. For instance, as described above, the computing system 126 may be configured to initiate one or more control actions associated with de-plugging the basket assembly(ies) 54 when it is determined that one or more of the basket assemblies 54 are plugged. Such control actions may include adjusting the ground speed of the implement/vehicle 10/12 and/or adjusting the force being applied to the basket assemblies 54 by the basket actuators 66.

It is to be understood that the steps of the control logic 200 and the method 300 are performed by the computing system 126 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 126 described herein, such as the control logic 200 and the method 300, is implemented in software code or instructions which are tangibly stored on a tangible computer readable medium. The computing system 126 loads the software code or instructions via a direct interface with the computer readable medium or via a wired and/or wireless network. Upon loading and executing such software code or instructions by the computing system 126, the computing system 126 may perform any of the functionality of the computing system 126 described herein, including any steps of the control logic 200 and the method 300 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An agricultural implement, comprising:
a frame;
a basket assembly supported on the frame such that the basket assembly is configured to roll relative to a surface of a field as the agricultural implement travels across the field, the basket assembly including a plurality of bars spaced circumferentially about an outer perimeter of the basket assembly;
a sensor configured to generate data indicative of a width of a bar of the plurality of the bars; and
a computing system communicatively coupled to the sensor, the computing system configured to:
determine the width of the bar based on the data generated by the sensor; and
determine when the basket assembly is plugged based on the determined width.

2. The agricultural implement of claim 1, wherein, when determining when the basket assembly is plugged, the computing system is configured to:
compare the determined width to a threshold value; and
when the determined width exceeds the threshold value, determine that the basket assembly is plugged.

3. The agricultural implement of claim 1, wherein the sensor comprises a transceiver-based sensor configured to emit output signals directed at the basket assembly and receive return signals based on reflections of the output signals off of the basket assembly.

4. The agricultural implement of claim 1, wherein the sensor comprises an imaging device configured to generate image data depicting the basket assembly.

5. The agricultural implement of claim 1, wherein the computing system is further configured to initiate a control action associated with de-plugging the basket assembly when it is determined that the basket assembly is plugged.

6. A system for monitoring basket plugging of an agricultural implement, the system comprising:
a basket assembly configured to roll relative to a surface of a field as the agricultural implement travels across the field, the basket assembly including a plurality of bars spaced circumferentially about an outer perimeter of the basket assembly;
a sensor configured to generate data indicative of a width of a bar of the plurality of the bars; and
a computing system communicatively coupled to the sensor, the computing system configured to:
determine the width of the bar based on the data generated by the sensor; and
determine when the basket assembly is plugged based on the determined width.

7. The system of claim 6, wherein, when determining when the basket assembly is plugged, the computing system is configured to:
compare the determined width to a threshold value; and
when the determined width exceeds the threshold value, determine that the basket assembly is plugged.

8. The system of claim 6, wherein the sensor comprises a transceiver-based sensor configured to emit output signals directed at the basket assembly and receive return signals based on reflections of the output signals off of the basket assembly.

9. The system of claim 8, wherein, when determining the width of the bar, the computing system is configured to determine the width of the bar based on a time period across which the return signals are received.

10. The system of claim 6, wherein the sensor comprises an imaging device configured to generate image data depicting the basket assembly.

11. The system of claim 10, wherein, when determining the width of the bar, the computing system is configured to:
identify the bar depicted within the generated image data; and
determine the width of the identified bar depicted within the generated image data.

12. The system of claim 6, wherein the computing system is further configured to initiate a control action associated with de-plugging the basket assembly when it is determined that the basket assembly is plugged.

13. The system of claim 12, wherein the control action comprises providing a notification to an operator of the agricultural implement that the basket assembly is plugged.

14. The system of claim 12, wherein the control action comprises adjusting a ground speed of the agricultural implement.

15. The system of claim 12, wherein the control action comprises adjusting a force being applied to the basket assembly.

16. A method for monitoring basket plugging of an agricultural implement, the agricultural implement including a basket assembly configured to roll relative to a surface of a field as the agricultural implement travels across the field, the basket assembly including a plurality of bars spaced circumferentially about an outer perimeter of the basket assembly, the method comprising:
receiving, with a computing system, sensor data indicative of a width of a bar of the plurality of the bars;
determining, with the computing system, the width of the bar based on the received sensor data;
determining, with the computing system, when the basket assembly is plugged based on the determined width; and
initiating, with the computing system, a control action associated with de-plugging the basket assembly when it is determined that the basket assembly is plugged.

17. The method of claim 16, wherein determining when the basket assembly is plugged comprises:
comparing, with the computing system, the determined width to a threshold value; and
when the determined width exceeds the threshold value, determining, with the computing system, that the basket assembly is plugged.

18. The method of claim 16, wherein receiving the sensor data comprises receiving, with the computing system, transceiver-based sensor data indicative of the width of the bar.

19. The method of claim 18, wherein determining the width of the bar comprises determining, with the computing system, the width of the bar based on a time period across which the return signals are received.

20. The method of claim 16, wherein receiving the sensor data comprises receiving, with the computing system, image data depicting the basket assembly.
